(19) United States
(12) Patent Application Publication
(10) Pub. No.: US 2026/0148145 A1
(43) Pub. Date: May 28, 2026

(54) Hybrid Data Clustering Using Machine Learning

(71) Applicant: Oracle International Corporation, Redwood Shores, CA (US)

(72) Inventors: Prosenjit Ghosh, Bengaluru (IN); Diljeet Singh Sethi, New Delhi (IN); Subramanyam Iyer, Pleasanton, CA (US); Ranip Hore, Bengaluru (IN); Ajay Ananth Prabhu, Dublin, CA (US); Leela Basavaiah, Bengaluru (IN)

(73) Assignee: Oracle International Corporation, Redwood Shores, CA (US)

(21) Appl. No.: 18/956,893

(22) Filed: Nov. 22, 2024

(51) Int. Cl. G06N 20/20; G06F 16/28

(52) U.S. Cl. CPC G06N 20/20; G06F 16/285

(57) ABSTRACT

Techniques for dynamically generating and updating clusters for categorizing data by using a hybrid implementation of supervised and unsupervised machine learning models are disclosed. A system trains a supervised prediction-type machine learning model to categorize data into a design-time defined set of data clusters. The system trains the prediction-type model using a training data set to generate predictions for assigning data to design-time defined data clusters. If the prediction-type model predicts that a data record does not correspond to any of the design-time defined data clusters, the system applies an unsupervised clustering-type machine learning model to the data record. The clustering-type model predicts a data cluster for the record. If the system detects a retraining trigger, the system retrains the classification-type model to include a new classification based on a runtime defined data cluster generated by the clustering-type model.

### TECHNICAL FIELD

The present disclosure relates to data management systems. In particular, the present disclosure relates to categorizing data.

### BACKGROUND

Data management systems support data classification for convenient data retrieval and handling. For example, customer service systems support the classification of customer service requests or tickets to direct different types of requests to different teams. Some approaches to classifying data require user input. For example, support teams may identify different keywords associated with different types of tickets and assign those keywords to the tickets. User-driven approaches are not readily scalable, due to the large volume of data and comparatively limited availability of support teams to perform data classification. In addition, user-driven approaches are error-prone; different users may assign different keywords to different tickets relating to the same topic. Thus, user-driven approaches can impede the functioning of data management systems by fragmenting related data (e.g., tickets on similar topics but with different keywords assigned to them), resulting in a need for more searches to locate related data. More searches means greater strain on the data management system, requiring additional compute cycles, memory, and network bandwidth.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIGS. 2A and 2B illustrate an example set of operations for generating data cluster definitions at design-time and at runtime to cluster data records in accordance with one or more embodiments;

FIG. 3 illustrates an example set of operations for training a predictive classification-type machine learning model;

FIGS. 4A and 4B illustrate an example embodiment; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. HYBRID DATA CLUSTERING ARCHITECTURE
3. HYBRID DATA CLUSTERING
4. TRAINING MACHINE LEARNING MODEL FOR DATA CLASSIFICATION
5. EXAMPLE EMBODIMENT
6. COMPUTER NETWORKS AND CLOUD NETWORKS
7. HARDWARE OVERVIEW
8. MISCELLANEOUS; EXTENSIONS

### 1. GENERAL OVERVIEW

One or more embodiments generate and update clusters for categorizing data by using a hybrid implementation of supervised and unsupervised machine learning models. A system trains a supervised prediction-type machine learning model at design-time to categorize data into a defined set of data clusters. The system trains the prediction-type model using a training data set to generate predictions for assigning data to data clusters corresponding to the specified categories. For example, the system may begin with five predefined categories. For example, a user may supply input that defines the baseline categories and may specify keywords associated with the respective categories. The system obtains a training data set based on the specified categories and keywords. At runtime, the model receives a data record. The model generates a prediction to assign the data record to one of the data clusters corresponding to one of the specified categories. Alternatively, the model may generate a prediction that a particular data record does not correspond to any of the data clusters corresponding to the specified categories. If the model predicts that a data record does not correspond to any of the data clusters corresponding to the specified categories, the system applies an unsupervised clustering-type machine learning model to the data record. The clustering-type model predicts, at runtime, a data cluster for the record that does not correspond to one of the predefined categories. The data cluster may be a new data cluster, i.e., it may need to be created. Additionally, or alternatively, the data cluster may be an existing data cluster associated with a previously processed data record that also did not correspond to any of the predefined categories. The data clusters generated by the clustering-type model at runtime are separate from the specified data clusters defined at design-time for the supervised model. Using a hybrid implementation of supervised and unsupervised machine learning models, the system allows for a baseline set of data clusters to be defined prior to ingesting input data while providing a dynamic and changing set of additional data clusters based on data ingested at runtime.

One or more embodiments generate a set of model retraining data to retrain the supervised machine learning model based on clustering data generated by the unsupervised machine learning model. The supervised model classifies data records into a design-time defined set of data clusters. The unsupervised clustering-type model generates additional data clusters based on data ingested at runtime. If a model retraining trigger is detected, the system retrains the supervised model with an updated training data set. For example, the system may determine that one of the data clusters generated by the clustering-type model includes a number of data records that exceeds a threshold number. The system may generate an updated training data set for the supervised model that includes the data records in the new data cluster. The retrained supervised model adds the new data cluster to the set of specified data clusters. As another example, the system may determine that one of the specified data clusters associated with the supervised model has a number of data records that falls below a threshold number. The system may generate a new training data set that omits the data cluster from among the specified data clusters. According to yet another example, the system may identify anomalies in data record categorizations. For example, the system may determine that the number of miscategorized data records in a cluster exceeds a threshold. The system obtains an updated training data set with the correct categorizations for the miscategorized data records.

One or more embodiments monitor, in real-time, data record attributes of data records associated with data clusters, to identify and remediate anomalies among the data records. For example, a system may categorize work tickets into data clusters for action by operators. The system may monitor (a) a number of tickets categorized in different data clusters and (b) the status of tickets categorized in different data clusters. If a number of tickets categorized in a particular cluster exceeds a threshold number, the system may tag the cluster for remedial action. Remedial action may include assigning additional computing resources to managing the work tickets. Additionally, or alternatively, remedial action may include recategorizing some of the work tickets associated with a data cluster. For example, a system may retrain a machine learning model to split a data cluster into two or more separate data clusters.

One or more embodiments described in this Specification and/or recited in the claims may not be included in this General Overview section.

### 2. HYBRID DATA CLUSTERING ARCHITECTURE

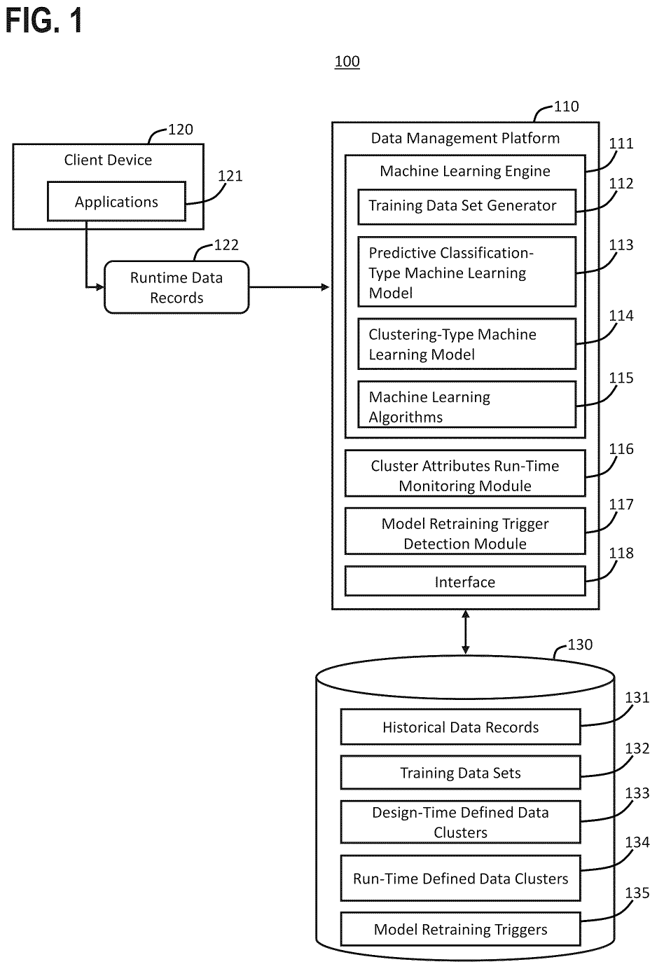

FIG. 1 illustrates a system 100 in accordance with one or more embodiments. As illustrated in FIG. 1, system 100 includes a data management platform 110, a client device 120, and a data repository 130. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

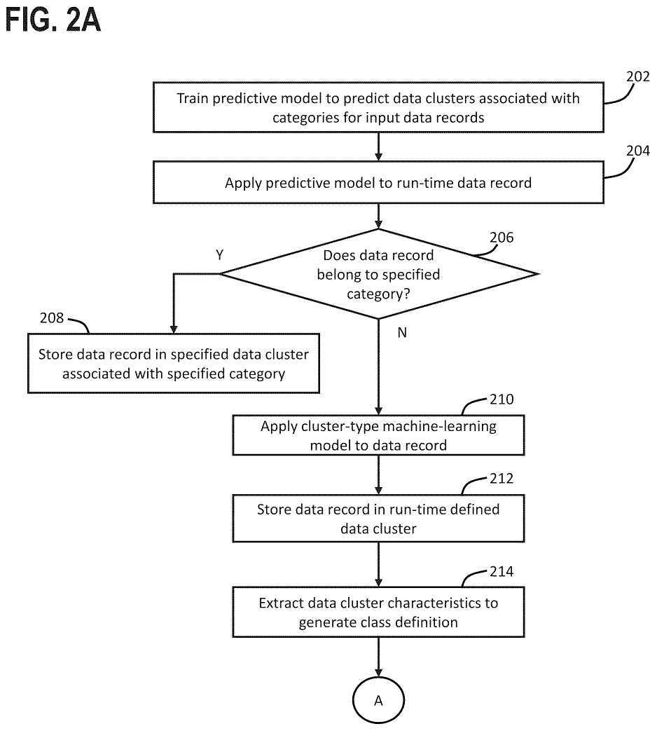

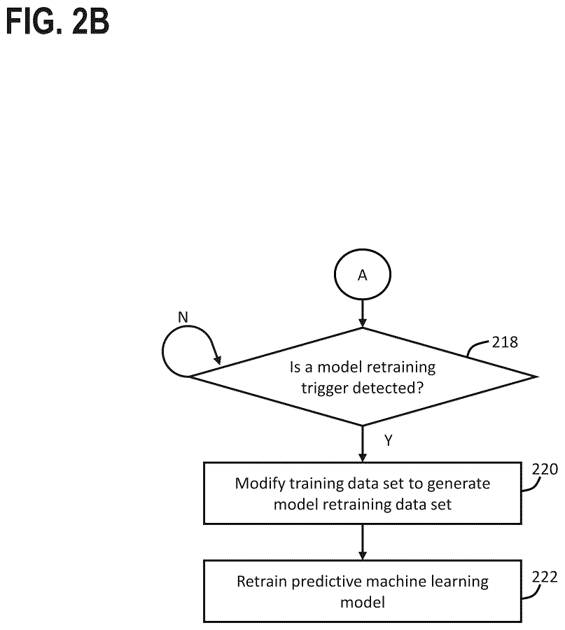

In one or more embodiments, a data management platform 110 refers to hardware and/or software configured to perform operations described herein for generating, implementing, and retraining a hybrid configuration of prediction-type machine learning models and clustering-type machine learning models to create and update data clusters. Examples of operations for generating, implementing, and retraining a hybrid configuration of prediction-type machine learning models and clustering-type machine learning models are described below with reference to FIGS. 2A and 2B.

In an embodiment, a data management platform 110 is implemented on one or more digital devices. The term “digital device” refers to any hardware device that includes a processor or sets of processors. A digital device may refer to a physical device executing an application or a virtual machine running on a physical device. Examples of digital devices include a computer, a tablet, a laptop, a desktop, a netbook, a server, a web server, a network policy server, a proxy server, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

The data management platform 110 includes a machine learning engine 111. The machine learning engine 111 trains a predictive classification-type machine learning model 113 based on a training data set generated by the training data set generator 112. According to one example, a user accesses an application 121 running on a client device 120. The application 121 presents a user interface to allow a user to define data categories. The user interface may include fields for a category name and keywords. A user enters or selects a category name and a set of keywords for specified categories.

In one or more embodiments, a user interacts with the data management platform 110 via the interface 118. Interface 118 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 118 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 118 is specified in one or more other languages, such as Java, C, or C++.

The training data set generator 112 generates a training data set 132 based on the categories and keywords entered and selected by the user. The training data set generator 112 generates the training data set 132 by accessing historical data records 131 in the data repository 130 that match the keywords entered by user. Additionally, or alternatively, the training data set generator 112 may fabricate new data records 131 to be included in the training data set based on the user input or selection of keywords and categories.

The machine learning engine generates a predictive classification-type machine learning model 113 based on the training data set 132 generated by the training data set generator 112. In one embodiment, the system generates the predictive classification-type machine learning model 113 using a machine learning algorithm 115. The machine learning algorithm 115 is an algorithm that can be iterated to train a target model f that best maps a set of input variables to an output variable using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm, which in turn updates the target model f.

Additionally, or alternatively, a machine learning algorithm 115 generates a target model f such that when the target model f is applied to the datasets of the training data, a maximum number of results determined by the target model f matches the labels of the training data. Different target models be generated based on different machine learning algorithms 115 and/or different sets of training data.

In one or more embodiments, the predictive classification-type machine learning model 113 is implemented and executed by pairing processing components with data storage components. Processing components include central processing units (CPUs), graphics processing units (GPUs), tensor processing units (TPUs), field-programmable gate arrays (FPGAs), and application-specific integrated circuits (ASICs). Data storage components include on-chip memory, dynamic random-access memory (DRAM), high-bandwidth memory (HBM), and flash storage.

In one or more embodiments, the predictive classification-type machine learning model is a neural network. The neural network is a computational model configured to recognize patterns learned from training data and make predictions or classifications based on the recognized patterns. The neural network includes an input layer that receives raw data or features. Each neuron in the input layer represents one feature of the data. For example, a set of neurons may represent a respective set of keywords. Additional neurons may represent additional features, such as source data describing a source of a data record, author data describing an author of a data record, temporal data, record type data describing a type of the data record, and additional words, values, or tokens in the data record.

The neural network further includes a set of hidden layers that are the processing layers between the input and output layers. The hidden layers perform complex computations on the data. A hidden layer includes several neurons. A neuron in a hidden layer applies a transformation to its input values, enabling the network to learn complex patterns. Computations performed by hidden layer neurons include applying a bias to a weighted sum of inputs from previous neural layers and applying an activation function to the weighted sum. Examples of activation functions include a sigmoid function, a rectified linear unit (ReLU) function, a Tanh function, and a SoftMax function.

The neural network further includes an output layer. The output layer provides the final result of the neural network's computations. The predictive classification-type machine learning model embodied as a neural network includes multiple output neurons. Each output neuron represents a class. The output layer may further include a neuron representing none of the specified classes. When the model receives a set of input data representing a data record, the predictive classification-type machine learning model embodied as a neural network classifies the data record as one of the specified classes by generating an output value at a corresponding output neuron. In addition, the model may classify the data record as none of the specified classes by generating an output value on an output neuron representing “none” of the specified classes.

In one or more embodiments, the neural network is structured as sets of neurons organized in an array. Each neuron includes a data storage element such as a register. Each neuron includes a data processing element such as a GPU. Multiple neurons may share data storage elements and data processing elements.

While an embodiment is described above where the predictive classification-type machine learning model is a neural network, in some embodiments, the model is embodied as a decision tree classifier model, a random forest classifier model, a support vector machine (SVM) model, a Naïve Bayes classifier model, a gradient boosting machines (GBM) model, or a transformer-type model.

The machine learning engine 111 further trains a clustering-type machine learning model 114. In some embodiments, the clustering-type machine learning model is not provided with a number of clusters. Instead, the model determines a number of different clusters for classifying data based on features within the data. The clustering-type machine learning model may be, for example, a hierarchical agglomerative clustering (HAC) type model. The HAC model generates a hierarchy of clusters by iteratively merging smaller clusters into larger ones. The HAC model starts with each data point as an individual cluster and successively merges clusters based on their similarity until all points are combined into a single cluster or until a stopping criterion is met. The HAC produces a dendrogram that represents clusters at various levels of similarity. Cutting the dendrogram at different levels results in retrieving clusters at various granularities.

In the embodiment in which the clustering-type machine learning model is an HAC model, the machine learning engine 111 trains the model on the historical data records 131. Training the model includes initializing clusters by starting each data point, or data record, as its own cluster. The machine learning engine 111 computes similarities among the clusters based on a selected distance, such as a Euclidian distance, a Manhattan distance, or a Cosine similarity. The machine learning engine 111 merges the closest clusters with each other to generate a new cluster based on linkage criteria. For example, the machine learning engine 111 may combine two clusters based on a distance between the closest points of the two clusters, the farthest points of the two clusters, or by minimizing the increase in total within-cluster variance after merging. The machine learning engine 111 iterates the process to generate additional levels of the dendrogram with each level higher in the hierarchy having fewer clusters than the level below.

Based on receiving the user input via the client device 120, the machine learning engine 111 trains the predictive classification-type machine learning model 113 prior to runtime. At runtime, the data management platform 110 receives a set of runtime data records 122 from the client device 120. In one example, the client device 120 runs a customer support application 121. The application generates customer requests or tickets. The customer requests or tickets include descriptions of client requests and/or codes and values associated with the requests. The data management platform 110 applies the predictive classification-type machine learning model 113 to the data records to generate a set of design-time defined data clusters 133.

The predictive classification-type machine learning model 113 includes a classification representing “none” of the user-specified classes. If the data management platform 110 detects that a data record has been classified by the predictive classification-type machine learning model 113 as “none” of the user-specified classes, the data management platform 110 applies the clustering-type machine learning model 114 to the data record, resulting in a set of runtime generated data clusters 134.

The data management platform 110 includes a model retraining trigger detection module 117. The model retraining trigger detection module 117 triggers retraining of the predictive classification-type machine learning model 113 when a model retraining trigger 135 is detected. For example, a cluster attributes runtime monitoring module 116 may determine at runtime that one of the data clusters 134 generated by the clustering-type model 114 includes a number of data records exceeding a threshold. The training data set generator 112 may generate an updated training data set 132 for the classification-type model 113 that includes the data records in the new data cluster generated by the clustering-type model 114. The retrained predictive classification-type model 113 adds a new classification corresponding to the new data cluster to the set of previously specified classes. Adding a new classification may include, for example, the training data set generator 112 extracting from the set of data records sets of keywords that distinguish the new data cluster from existing data clusters.

As another example, the cluster attributes runtime monitoring module 116 may determine that one of the design-time defined data clusters 133 associated with the predictive classification-type model 113 has a number of data records that fall below a threshold. The training data set generator 112 may generate a new training data set that omits the data cluster from among the design-time defined data clusters 133. According to yet another example, the cluster attributes runtime monitoring module 116 may identify anomalies in data record categorizations. For example, the cluster attributes runtime monitoring module 116 may determine that the number of miscategorized data records in a cluster exceeds a threshold. The training data set generator obtains an updated training data set 132 with the correct categorizations for the miscategorized data records.

In one or more embodiments, the machine learning engine 111 retrains the predictive classification-type machine learning model 113 to add a new cluster, selected from among the runtime generated data clusters 134, to the set of design-time defined data clusters 133. Retraining the predictive classification-type machine learning model 113 may include, for example, adding one or more additional features, such as keywords, to a set of input data, adding one or more additional input neurons to a neural network, and adding an additional output neuron, representing the new classification, to the neural network.

In one embodiment, the machine learning engine 111 retrains the predictive classification-type machine learning model 113 to add a new cluster to the set of design-time defined data clusters 133 without modifying features associated with the existing set of design-time defined data clusters 133. For example, if the existing set of design-time defined data clusters 133 correspond to respective sets of keywords, the machine learning engine 111 retrains the predictive classification-type machine learning model 113 to add the new cluster to the set of design-time defined data clusters 133 without modifying the sets of keywords associated with the existing design-time defined data clusters 133.

Alternatively, the machine learning engine 111 retrains the predictive classification-type machine learning model 113 to add a new cluster to the set of design-time defined data clusters 133 while modifying features associated with the existing set of design-time defined data clusters 133. For example, if the existing set of design-time defined data clusters 133 correspond to respective sets of keywords, cluster attributes runtime monitoring module 116 may determine that the keywords associated with an existing cluster should be modified. As an example, a keyword “vehicle” may result in a cluster of data records that is handled by multiple different service groups in an organization. The machine learning engine 111 may retrain the classification-type model 113 by changing the keyword for an existing cluster from “vehicle” to “automobile”. The machine learning engine 111 may further retrain the classification-type model 113 by generating a new data cluster associated with the keyword “watercraft.” In other words, retraining the classification-type model 113 may include modifying features of existing classes as well as generating new features for new classes.

In one or more embodiments, a data repository 130 is any type of storage unit and/or device (e.g., a file system, database, collection of tables, or any other storage mechanism) for storing data. Furthermore, a data repository 130 may include multiple different storage units and/or devices. The multiple different storage units and/or devices may or may not be of the same type or located at the same physical site. Furthermore, a data repository 130 may be implemented or executed on the same computing system as the data management platform 110. Additionally, or alternatively, a data repository 130 may be implemented or executed on a computing system separate from the data management platform 110. The data repository 130 may be communicatively coupled to the data management platform 110 via a direct connection or via a network.

Information describing historical data records 131, training data sets 132, design-time defined data clusters 133, runtime generated data clusters 134, and model retraining triggers 135 may be implemented across any of components within the system 100. However, this information is illustrated within the data repository 130 for purposes of clarity and explanation.

Additional embodiments and/or examples relating to computer networks are described below in Section 6, titled “Computer Networks and Cloud Networks.”

### 3. HYBRID DATA CLUSTERING

FIGS. 2A and 2B illustrate an example set of operations for generating, implementing, and retraining a hybrid configuration of prediction-type machine learning models and clustering-type machine learning models in accordance with one or more embodiments. One or more operations illustrated in FIGS. 2A and 2B may be modified, rearranged, or omitted. Accordingly, the particular sequence of operations illustrated in FIGS. 2A and 2B should not be construed as limiting the scope of one or more embodiments.

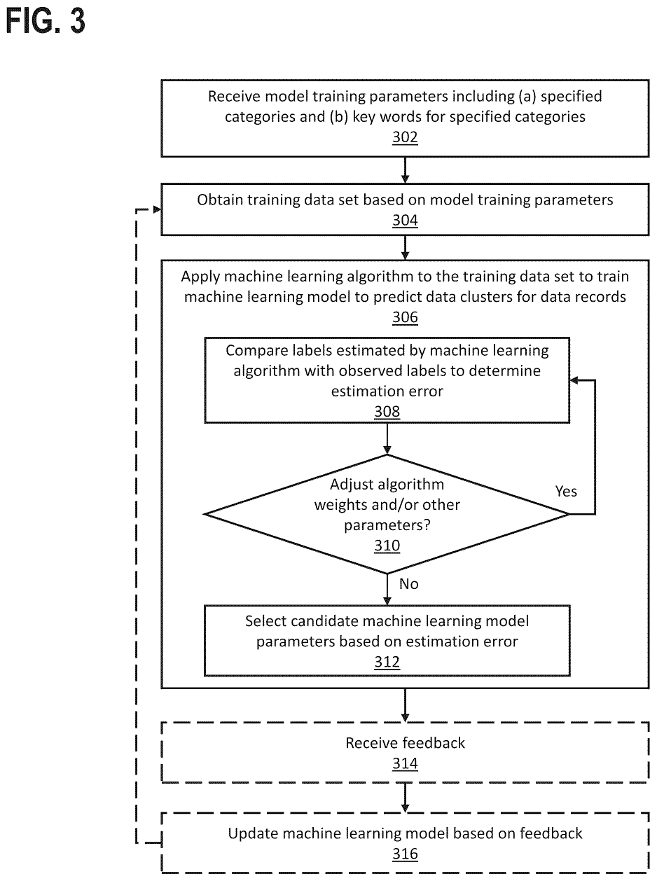

In an embodiment, a system trains a predictive classification-type machine learning model to classify data records into classes or clusters (Operation 202). An example of training the predictive classification-type machine learning model is described with reference to FIG. 3.

The system applies the classification-type model to a runtime data record (Operation 204). The classification-type model classifies the data record in one class among a set of predefined classes or in a “none” class. For example, the classification-type model may classify a first data record in a first class associated with a first data cluster of data records.

The system may obtain the data records, which the system then provides to the classification-type model, either from stored data or in real-time as the data records are received by the system. In one example, the system stores the data records in a queue. The system retrieves the data records from the queue and provides them to the classification-type model based on system metrics, including network traffic and an amount of storage capacity remaining in the queue.

The system determines if the classification-type machine learning model has classified the first data record in a specified category or in the “none” category (Operation 206). For example, a classification-type model may be trained to classify data records among either one of three categories or a “none” category. The three categories may correspond to three different transaction types (e.g., sales, product A support, product B support).

If the system determines the data record has been classified among one of the specified categories, the system stores the data record in a data cluster associated with the specified category (Operation 208). For example, the system may store data records in predefined folders in a virtual storage system. As another example, the system may tag the data records with classification tags. A user may interact with a user interface to search for data records marked with particular tags. As another example, the system routes data records to destination devices based on classifications. For example, a system may maintain servers or virtual machines associated with different work groups. The system may route data records to respective servers or virtual machines based on the classifications.

If the system determines that the classification-type model did not classify the data record among the set of specified categories, the system applies a clustering-type machine-learning model to the data record (Operation 210). The clustering-type machine-learning model generates, at runtime, one or more new clusters based on receiving as input data one or more data records.

In one example, the clustering-type machine learning model is a hierarchical agglomerative clustering (HAC) type model. The HAC model generates a hierarchy of clusters by iteratively merging smaller clusters into larger ones. The HAC model starts with each data point as an individual cluster and successively merges clusters based on their similarity until all points are combined into a single cluster or until a stopping criterion is met. The HAC produces a dendrogram that represents clusters at various levels of similarity. Cutting the dendrogram at different levels results in retrieving clusters at various granularities.

In the embodiment where the clustering-type model is an HAC model, the system provides the HAC model with data records at runtime that the classification-type model identified as belonging to none of the specified categories that the classification-type model is trained to identify. The HAC model designates each received record as a separate cluster. The HAC model then successively merges clusters based on their similarity until a stopping criterion is met. As a new data record is received, the HAC model again (a) designates the record as a unique cluster and (b) merges the record into an existing cluster or with an existing record that represents a cluster.

In one or more embodiments, the clustering type model does not require that a number of clusters be specified prior to applying the model to data records. While an example of an HAC type clustering model is described above, embodiments are not limited to an HAC type model. Additional clustering type models that do not require the number of clusters be pre-specified include gaussian mixture models (GMM) using Bayesian information criteria (BIC) or Akaike information criteria (AIC) to determine an optimal number of clusters. Another example of a clustering type model that does not require the number of clusters be pre-specified is a hierarchical density-based spatial clustering of applications with noise (HDBSCAN) model. The HDBSCAN type model uses a minimum cluster size parameter to generate a hierarchy of clusters based on varying density levels.

The system stores the data record in a runtime defined data cluster (Operation 212). In the present specification and claims, the data clusters that correspond to specified categories identified by the classification-type model are referred to as design-time data clusters since the classification-type model is trained or “designed” to identify records in a predefined set of categories. In contrast, the data clusters generated by the clustering-type model are referred to as runtime defined data clusters. The clustering-type model generates the clusters as new data records are received at runtime rather than classifying records in predefined clusters that are identified in training data used to train the model at design-time.

The system extracts cluster characteristics from the runtime defined data clusters to generate class definitions for the runtime defined data clusters (Operation 214). For example, the system may identify common keywords and values shared by records included in a cluster that differentiate the records from those included in other clusters. In one or more embodiments, the system provides a user interface to allow a user to review records included in runtime defined data clusters. The user interface may include functionality to generate a name or classification for the runtime defined data clusters.

Referring to FIG. 2B, the system determines if a model retraining trigger is detected (Operation 218). For example, the system may determine at runtime that one of the runtime defined data clusters generated by the clustering-type model includes a number of data records exceeding a threshold. As another example, the system may determine at runtime that one of the design-time defined data clusters generated by the prediction-type model includes a number of records that is less than a threshold. According to yet another example, the system may identify anomalies in data record categorizations in data clusters. For example, the system may determine that the number of miscategorized data records in a cluster exceeds a threshold.

Based on detecting the model retraining trigger, the system modifies the training data set to generate the model retraining data set (Operation 220). The system generates a revised training data set that includes the data records in the new, design-time defined data cluster generated by the clustering-type model. A system may label the data records to identify features in the data records and the classification associated with the data records.

The system retrains the predictive classification-type model using the modified model retraining data set (Operation 222). In one or more embodiments, the system retrains the predictive classification-type machine learning model to add a new cluster selected from among the runtime defined data clusters generated by the clustering-type model. The system determines a classification label for the runtime defined data cluster. The system further identifies any unique features that are included in the data records of the runtime defined cluster that may not be included in the data records of the existing design-time defined clusters. The system retrains the classification-type model to add the new cluster by adding one or more additional features, such as keywords, to a set of input data to be provided to the classification-type model, adding one or more additional input neurons to a neural network, and adding an additional output neuron, representing the new classification, to the neural network.

In one embodiment, the system retrains the predictive classification-type machine learning model to add and/or remove clusters to/from the set of design-time defined data clusters without modifying features associated with the existing set of design-time defined data clusters. For example, if the existing set of design-time defined data clusters correspond to respective sets of keywords, the system retrains the predictive classification-type machine learning model to add the new cluster to the set of design-time defined data clusters without modifying the sets of keywords associated with the existing design-time defined data clusters.

Alternatively, the system may retrain the predictive classification-type machine learning model to add a new cluster to the set of design-time defined data clusters while modifying features associated with the existing set of design-time defined data clusters. For example, if the existing set of design-time defined data clusters correspond to respective sets of keywords, the system may determine that the keywords associated with an existing design-time defined cluster should be modified. As an example, a keyword “Product A” may result in a cluster of data records that is handled by multiple different service groups in an organization. The system may retrain the classification-type model by changing the keyword for an existing design-time defined cluster from “Product A” to “Product A.1”. The system may further retrain the classification-type model by generating a new data cluster associated with the keyword “Product A.2.” In other words, retraining the classification-type model may include modifying features of existing design-time defined classes as well as generating new features for new classes.

Based on retraining the classification-type model, the system returns to Operation 204 to receive additional data records. The data cluster that was previously a runtime defined data cluster is included among the design-time defined data clusters associated with the output classification predictions generated by the retrained classification-type model. The system continuously monitors the data clusters to detect model-retraining triggers. Accordingly, the system dynamically and iteratively generates new, runtime defined data clusters that store data concurrently with design-time defined data clusters.

### 4. TRAINING MACHINE LEARNING MODEL FOR DATA CLASSIFICATION

FIG. 3 illustrates an example set of operations for training a machine learning model to classify data records into a defined set of categories that are defined in a training data set at design-time in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

A system receives model training parameters (Operation 302). The model training parameters include (a) a set of defined categories and (b) keywords associated with the respective defined categories. For example, a system may present a user with a user interface including a field for “category” and fields for “keywords.”

In some embodiments, the system obtains historical data records based on the model training parameters. The system may search a set of historical data records for the keywords input by the user. The system may assign a category label to a data record based on the keywords identified in the data record. In one example embodiment, the historical data records include customer service records and/or tickets provided to a customer service or work order management platform.

The system obtains a set of training data (Operation 304). For example, to obtain the set of training data, the system may generate the set of training data based on historical data records. The set of training data includes, for a particular data record, at least one classification label. For example, the system may identify in the historical data a particular service ticket specifying three services to be performed by an operator. The system may identify keywords in the descriptions of the three services. The system assigns at least one classification label to the service ticket from among the defined categories based on the keywords in the service ticket.

In some embodiments, generating the training data set includes generating a set of feature vectors for the labeled data records. A feature vector for a data record may be n-dimensional, where n represents the number of features in the vector. The number of features that are selected may vary depending on the implementation. The features may be curated in a supervised approach such as a user input selected by a user. Additionally, or alternatively, the features may be automatically selected from extracted attributes during model training and/or tuning. For example, a user may specify a number of categories that the classification-type model should include in a set of output data. The model may identify, during training, the categories to include. In some embodiments, a feature within a feature vector is represented numerically by one or more bits. The system may convert categorical attributes to numerical representations using an encoding scheme, such as one-hot encoding, label encoding, and binary encoding. One-hot encoding creates a unique binary feature for each possible category in an original feature. In one-hot encoding, when one feature has a value of 1, the remaining features have a value of 0. For example, if a type of service in a service ticket has ten different categories, the system may generate ten different features of an input data set. When one category is present (e.g., value “1”), the remaining features are assigned a value “0.” According to another example, the system may perform label encoding by assigning a unique numerical value to each category. According to yet another example, the system performs binary encoding by converting numerical values to binary digits and creating a new feature for each digit.

The system applies a machine learning algorithm to the training data set to train the machine learning model (Operation 306). For example, the machine learning algorithm may analyze the training data set to train neurons of a neural network with weights and offsets to associate data records with record classification labels.

In some embodiments, the system iteratively applies the machine learning algorithm to a set of input data to generate an output set of labels, compares the generate labels to pre-generated labels associated with the input data, adjusts weights and offsets of the algorithm based on an error, and applies the algorithm to another set of input data.

In some embodiments, the system compares the labels estimated through the one or more iterations of the machine learning model algorithm with observed labels to determine an estimation error (Operation 308). The system may perform this comparison for a test set of data records, which may be a subset of data records in the training dataset that were not used to generate and fit the candidate models. The total estimation error for a particular iteration of the machine learning algorithm may be computed as a function of the magnitude of the difference and/or the number of data records for which the estimated label was wrongly predicted.

In some embodiments, the system determines whether or not to adjust the weights and/or other model parameters based on the estimation error (Operation 310). Adjustments may be made until a candidate model that minimizes the estimation error or otherwise achieves a threshold level of estimation error is identified. The process may return to Operation 308 to make adjustments and continue training the machine learning model.

In some embodiments, the system selects machine learning model parameters based on the estimation error meeting a threshold accuracy level (Operation 312). For example, the system may select a set of parameter values for a machine learning model based on determining that the trained model has an accuracy level for predicting labels for data records of at least 98%.

In some embodiments, the system trains a neural network using backpropagation. Backpropagation is a process of updating cell states in the neural network based on gradients determined as a function of the estimation error. With backpropagation, nodes are assigned a fraction of the estimated error based on the contribution to the output and adjusted based on the fraction. Additionally, or alternatively, the system may train other types of machine learning models. For example, the system may adjust the boundaries of a hyperplane in a support vector machine or node weights within a decision tree model to minimize estimation error. Once trained, the machine learning model may be used to estimate labels for new examples of expenses.

In embodiments in which the machine learning algorithm is a supervised machine learning algorithm, the system may obtain feedback on the various aspects of the analysis described above (Operation 314). For example, the feedback may affirm or revise labels generated by the machine learning model. The machine learning model may indicate that a particular data record is associated with one category. The system may receive feedback indicating that the particular data record should instead be associated with a different category. Based on the feedback, the machine learning training set may be updated, thereby improving its analytical accuracy (Operation 316). Once updated, the system may further train the machine learning model by optionally applying the model to additional training data sets.

### 5. EXAMPLE EMBODIMENT

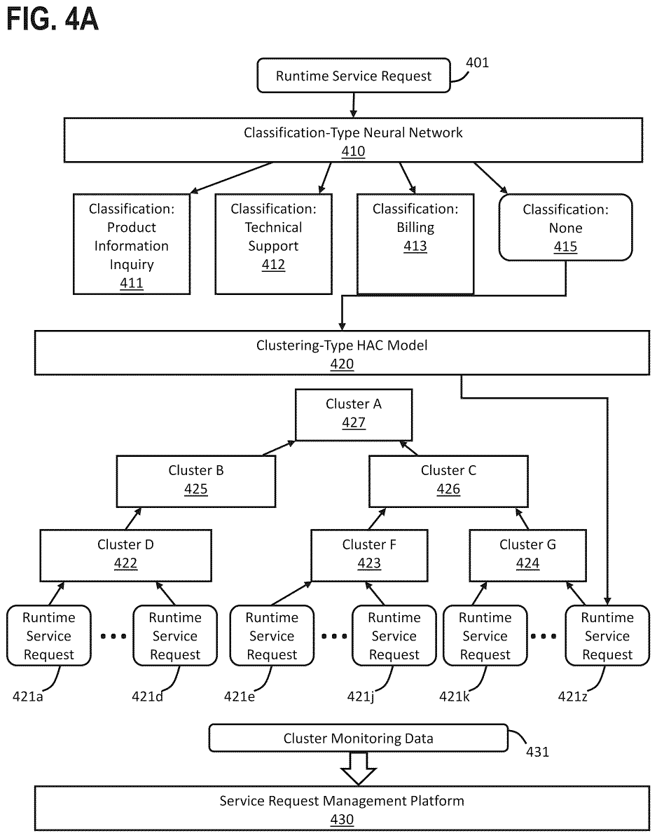

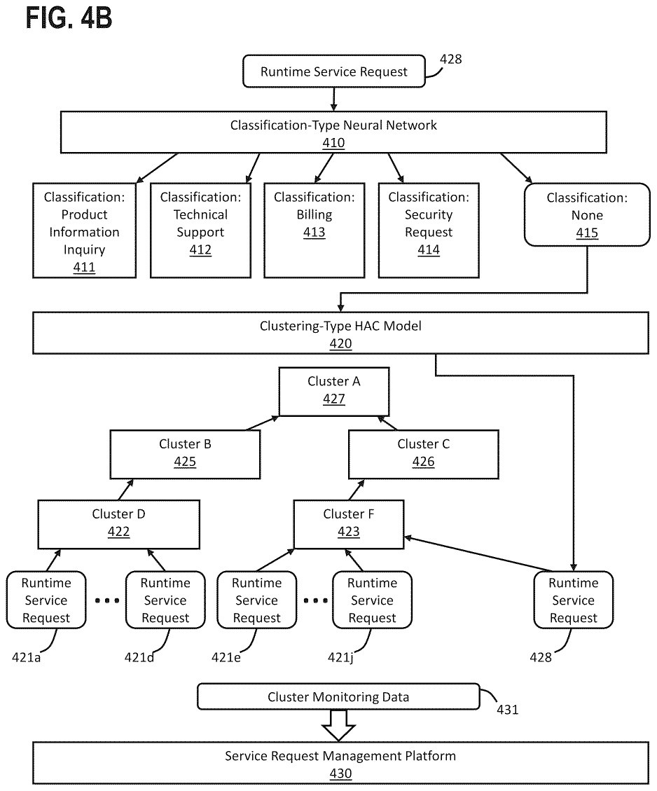

FIGS. 4A and 4B illustrate a detailed example for purposes of clarity. Components and/or operations described below should be understood as one specific example that may not be applicable to certain embodiments. Accordingly, components and/or operations described below should not be construed as limiting the scope of any of the claims.

A system provides a runtime service request 401 to a classification-type neural network 410. The classification-type neural network 410 has been trained at design-time to classify service requests among three specified categories: product information inquiries, technical support, and billing. The classification-type neural network 410 has further been trained at design-time to classify service requests that do not fall within the three specified categories as “none” (415). At runtime, the classification-type neural network 410 clusters runtime service requests in the clusters 411, 412, and 413, corresponding to the specified classifications: product information inquiries, technical support, and billing.

The classification-type neural network 410 receives a runtime service request 401. The classification-type neural network 410 classifies the service request 401 as “None,” meaning it does not fall within one of the design-time defined categories: product information inquiries, technical support, or billing.

The system provides the runtime service request 401 to the clustering-type HAC model 420. The clustering-type machine-learning model 420 generates, at runtime, data clusters based on runtime service requests. The HAC model 420 starts with individual runtime service requests 421a-421z as individual clusters. The model 420 successively merges clusters based on their similarity until all runtime service requests are combined into a single cluster 427 or until a stopping criterion is met. The clustering performed by the HAC model 420 produces a dendrogram that represents clusters at various levels of similarity. Cutting the dendrogram at different levels results in retrieving clusters at various granularities.

In the example embodiment illustrated in FIG. 4A, runtime service requests 421a-421d are clustered in Cluster D (422). Runtime service requests 421e-421j are clustered in Cluster F (423). Runtime service requests 421k-421z are clustered in Cluster G (424). Cluster D 422 further corresponds to Cluster B (425) at a next hierarchical tier of the dendrogram. Cluster F (423) and Cluster G (424) are clustered in Cluster C (426). Cluster B (425) and Cluster C (426) are clustered in Cluster A (427).

A service request management platform 430 monitors the data clusters of runtime service requests, including the design-time defined clusters 411-413 and the runtime defined clusters 422-427. The service request management platform 430 generates cluster monitoring data 431 based on monitoring the clusters. For example, the service request management platform 430 may determine the number of service requests in each cluster and the number and frequency of incorrectly classified service requests in each cluster.

The service request management platform 430 determines that a number of service requests in the cluster 424 exceeds a threshold number, triggering retraining of the classification-type neural network 410.

The service request management platform 430 extracts cluster characteristics from the service requests in the cluster 424. For example, the service request management platform 430 may identify frequently occurring keywords in the service requests. The service request management platform 430 may identify other features, including a source of the service requests and targets of the service requests.

Referring to FIG. 4B, the system retrains the predictive classification-type neural network 410 to include a new classification: security request. The system populates a data cluster 414 corresponding to the new classification with the service requests 401 and 421k-421z. The system retrains the classification-type neural network 410 by adding one or more input neurons to receive one or more new features. Retraining the neural network 410 further results in adding a new output neuron to the neural network. The new output neuron corresponds to the new classification: security request.

The system continues to receive runtime service requests. If the system determines that a runtime service request 428 does not fall within the design-time defined categories of product information inquiry, technical support, billing, or security request, then the system provides the runtime service request to the clustering-type HAC model 420. The HAC model 420 designates the runtime service request 428 as a new cluster. The HAC model 420 further determines that the runtime service request 428 falls within the cluster 423 based on a similarity of the runtime service request 428 with the runtime service requests 421e-421j.

According to the above example embodiment, the system generates a set of design-time defined data clusters that correspond to categories selected or approved by a user. The system further dynamically and iteratively generates new runtime defined data clusters that store data concurrently with design-time defined data clusters. The system retrains a predictive classification-type machine learning model based on classifications generated by a clustering-type machine learning model at runtime. The implementation of hybrid design-time defined clustering and runtime defined clustering allows operators to identify, monitor, and manage defined sets of data clusters without requiring the operators to manage every possible data cluster. By allowing an unsupervised clustering-type model to generate data clusters at runtime, a system may identify data clusters that operators may not be aware of at runtime. The system allows operators to then selectively modify design-time defined data clusters by adding or removing design-time defined data clusters based on characteristics of both the design-time defined data clusters and the runtime defined data clusters.

### 6. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

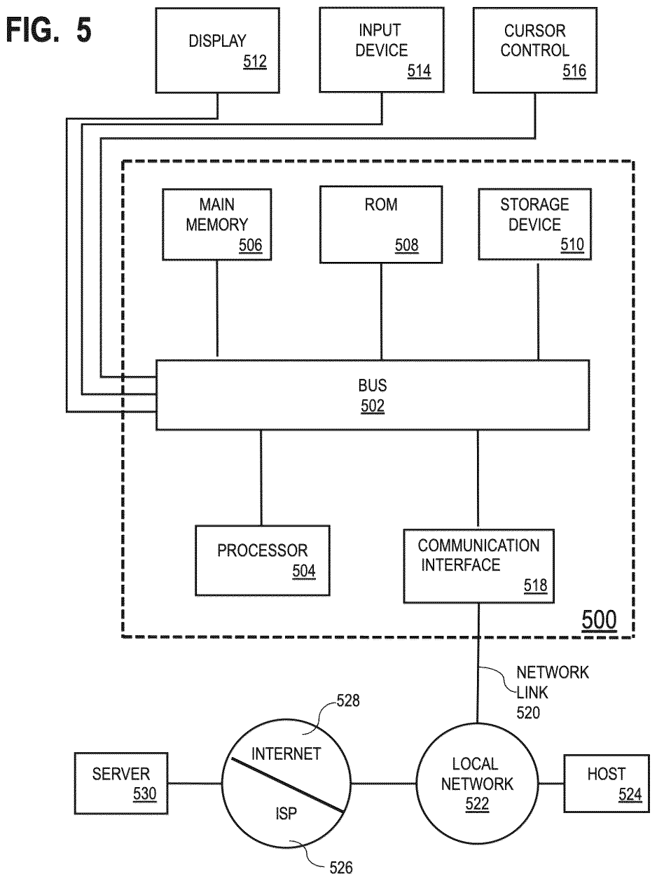

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid-State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
applying a first machine learning model to a first set of records to predict classifications for the first set of records among a first set of categories;
predicting, by the first machine learning model, that a first record, among the first set of records, is not categorized within the first set of categories;
based on determining that the first machine learning model predicted the first record is not categorized within the first set of categories:
applying, at runtime, a second machine learning model to the first record, the second machine learning model being a clustering-type model; and
based on applying the second machine learning model to the first record, mapping, at runtime, the first record to a first cluster of records associated with a first category, wherein the first category is not among the first set of categories.

2. The one or more non-transitory computer readable media of claim 1, wherein mapping the first record to the first cluster of records associated with the first category comprises generating, at runtime, a new cluster associated with the first record.

3. The one or more non-transitory computer readable media of claim 1, wherein the operations further comprise:
detecting a model retraining trigger; and
based on detecting the model retraining trigger:
identifying a second set of records mapped by the second machine learning model to the first category, the second set of records including the first record;
generating a model retraining data set including (a) an initial training data set used to train the first machine learning model, and (b) the second set of records; and
generating a third machine learning model by retraining the first machine learning model using the model retraining data set.

4. The one or more non-transitory computer readable media of claim 3, wherein the model retraining trigger is based on a number of records included in the first category.

5. The one or more non-transitory computer readable media of claim 1, wherein the operations further comprise:
detecting a model retraining trigger; and
based on detecting the model retraining trigger:
generating a model retraining data set; and
generating a third machine learning model by retraining the first machine learning model using the model retraining data set,
wherein the model retraining trigger includes determining a number of incorrect predictions by the first machine learning model exceeds a threshold, and
wherein the model retraining data set includes a first set of corrected record classifications generated by correcting incorrect predictions by the first machine learning model.

6. The one or more non-transitory computer readable media of claim 1, wherein the operations further comprise:
predicting, by the first machine learning model, that a second record, among the first set of records, does not fall within the first set of categories;
based on determining the first machine learning model predicted that the second record does not fall within the first set of categories:
applying the second machine learning model to the second record; and
based on applying the second machine learning model to the second record, mapping the second record to the first cluster of records associated with the first category.

7. The one or more non-transitory computer readable media of claim 1, wherein the operations further comprise:
predicting, by the first machine learning model, that a second record, among the first set of records, does not fall within the first set of categories;
based on determining the first machine learning model predicted that the second record does not fall within the first set of categories:
applying the second machine learning model to the second record; and
based on applying the second machine learning model to the second record, mapping the second record to a second cluster of records associated with a second category, wherein the second category is not among the first set of categories.

8. The one or more non-transitory computer readable media of claim 1, wherein the first machine learning model is a predictive-type machine learning model, and
wherein the second machine learning model is a clustering-type machine learning model.

9. The one or more non-transitory computer readable media of claim 1, wherein the operations further comprise:
training the first machine learning model at least by:
receiving a first set of input data specifying the first set of categories;
receiving a second set of input data specifying sets of attributes associated with the first set of categories, respectively;
obtaining a training data set of records labeled with the first set of categories and the sets of attributes associated with the first set of categories; and
generating the first machine learning model by training applying the training data set to a machine learning algorithm.

10. The one or more non-transitory computer readable media of claim 1, wherein applying the first machine learning model to the first set of records comprises:
receiving a sequence of records in real-time; and
monitoring, in real-time as the sequence of records is received, attributes of groups of records associated with respective categories among the first set of categories and the first category;
based on the monitoring the attributes of the groups of records, detecting an anomaly among at least one group of records associated with a second category;
based on detecting the anomaly:
generating a model retraining data set comprising one or more records configured to remediate the anomaly; and
retraining the first machine learning model using the model retraining data set.

11. A method comprising:
applying a first machine learning model to a first set of records to predict classifications for the first set of records among a first set of categories;
predicting, by the first machine learning model, that a first record, among the first set of records, is not categorized within the first set of categories;
based on determining that the first machine learning model predicted the first record is not categorized within the first set of categories:
applying, at runtime, a second machine learning model to the first record, the second machine learning model being a clustering-type model; and
based on applying the second machine learning model to the first record, mapping, at runtime, the first record to a first cluster of records associated with a first category, wherein the first category is not among the first set of categories.

12. The method of claim 11, wherein mapping the first record to the first cluster of records associated with the first category comprises generating, at runtime, a new cluster associated with the first record.

13. The method of claim 11, further comprising:
detecting a model retraining trigger; and
based on detecting the model retraining trigger:
identifying a second set of records mapped by the second machine learning model to the first category, the second set of records including the first record;
generating a model retraining data set including (a) an initial training data set used to train the first machine learning model, and (b) the second set of records; and
generating a third machine learning model by retraining the first machine learning model using the model retraining data set.

14. The method of claim 13, wherein the model retraining trigger is based on a number of records included in the first category.

15. The method of claim 11, further comprising:
detecting a model retraining trigger; and
based on detecting the model retraining trigger:
generating a model retraining data set; and
generating a third machine learning model by retraining the first machine learning model using the model retraining data set,
wherein the model retraining trigger includes determining a number of incorrect predictions by the first machine learning model exceeds a threshold, and
wherein the model retraining data set includes a first set of corrected record classifications generated by correcting incorrect predictions by the first machine learning model.

16. The method of claim 11, further comprising:
predicting, by the first machine learning model, that a second record, among the first set of records, does not fall within the first set of categories;
based on determining the first machine learning model predicted that the second record does not fall within the first set of categories:
applying the second machine learning model to the second record; and
based on applying the second machine learning model to the second record, mapping the second record to the first cluster of records associated with the first category.

17. The method of claim 11, further comprising:
predicting, by the first machine learning model, that a second record, among the first set of records, does not fall within the first set of categories;
based on determining the first machine learning model predicted that the second record does not fall within the first set of categories:
applying the second machine learning model to the second record; and
based on applying the second machine learning model to the second record, mapping the second record to a second cluster of records associated with a second category, wherein the second category is not among the first set of categories.

18. The method of claim 11, wherein the first machine learning model is a predictive-type machine learning model, and
wherein the second machine learning model is a clustering-type machine learning model.

19. The method of claim 11, further comprising:
training the first machine learning model at least by:
receiving a first set of input data specifying the first set of categories;
receiving a second set of input data specifying sets of attributes associated with the first set of categories, respectively;
obtaining a training data set of records labeled with the first set of categories and the sets of attributes associated with the first set of categories; and
generating the first machine learning model by training applying the training data set to a machine learning algorithm.

20. A system comprising:
at least one device including a hardware processor;
the system being configured to perform operations comprising:
applying a first machine learning model to a first set of records to predict classifications for the first set of records among a first set of categories;
predicting, by the first machine learning model, that a first record, among the first set of records, is not categorized within the first set of categories;
based on determining that the first machine learning model predicted the first record is not categorized within the first set of categories:
applying, at runtime, a second machine learning model to the first record, the second machine learning model being a clustering-type model; and
based on applying the second machine learning model to the first record, mapping, at runtime, the first record to a first cluster of records associated with a first category, wherein the first category is not among the first set of categories.
